(19) United States
(12) Patent Application Publication
(10) Pub. No.: US 2011/0277438 A1
(43) Pub. Date: Nov. 17, 2011

(54) Lawn Mower Blade

(76) Inventor: Anthony P. Perruso, JR., Loxahatchee, FL (US)

(21) Appl. No.: 13/086,727

(22) Filed: Apr. 14, 2011

Related U.S. Application Data
(60) Provisional application No. 61/324,645, filed on Apr. 15, 2010.

(51) Int. Cl. A01D 34/52

(52) U.S. Cl. 56/295

(57) ABSTRACT

The present invention is directed towards a rotary lawn mower blade designed to eject grass clippings away from the center of the blade. The rotary lawn mower includes a main body which has two opposing ends. The first end comprises a first leading cutting edge arranged opposite a first trailing edge. The first trailing edge has an upturned portion having sufficient height, length and configuration to redirect air flow generated when the main body is rotating to create pressurized air, thereby creating an increased force to disperse grass to the external environment. The second end comprises a second leading cutting edge arranged opposite a second trailing edge. The second trailing edge has an upturned portion having sufficient height, length and twist configuration to redirect air flow generated when the main body is rotating to create pressurized air, thereby creating an increased force to disperse grass to the external environment.

### CROSS REFERENCE TO RELATED APPLICATIONS

This application claims priority under 35 USC 119(e) to the U.S. Provisional Application 61/324,645, filed on Apr. 15, 2010, entitled, “Lawn Mower Blade”, the contents of which are herein incorporated by reference.

### FIELD OF THE INVENTION

The present invention relates to lawn care devices, and more particularly to a lawn mower blade constructed in such a manner to disperse cut grass away from a mowing device at distances further than standard cutting devices, thereby preventing grass build-up within the lawn mower device.

### BACKGROUND OF THE INVENTION

Whether you are a child performing weekly chores or a home owner who enjoys manicured lawns, many Americans have mowed a lawn at one point in their lives. With an estimated 25 million acres of turf in the United States, lawn mowing services have become a large industry. While large and sophisticated mowing machines have been developed, the average mowing machines utilize a rotary type blade to cut lawn areas. In its simplest form, the rotary lawn mower includes a housing unit, a rotary blade and a gas or electric powered engine which drives the blades. As the rotary blade rotates and cuts the blades of grass, the clippings are generally collected in a bag and disposed of in land fills.

Over the last several years, as land fill space has become an issue and global warming a concern, it has become en vogue and environmentally friendly to no longer bag the grass clippings. Instead, once cut by the mowing blade, the grass clippings are allowed to fall in place and remain on the lawn. While it is not uncommon for the average lawn mower to be able to disperse grass as the machine moves along the lawn, most mowers have limited ability to disperse such clippings a large distance. This can be a disadvantage as placing too much cut grass in a single place can choke those areas of the lawn, damaging the lawn itself and resulting in unsightly appearance of the lawn. Another limitation of standard mowing machines is that grass clippings can sometimes clog the chute area, resulting in stalling the lawnmower and dumping of the cut grass. Constant clogging not only damages both the rotary blade and the lawn mowing device but also increases the time it takes to actually cut the lawn as the user is required to stop and unclog the machine.

Therefore, what is needed is an improved rotary cutting blade that is capable of dispersing cut blades of grass from the lawn mower at a distance further than standard blades known in the art.

### DESCRIPTION OF THE PRIOR ART

Lawn mower blades are known in the prior art. Blades are typically designed with a small lift generating area that creates a draft, thereby pulling up the grass, in order to improve the quality of cutting. Alternatively, mulching blades are designed with notched areas or rake like teeth which provide the grass clippings extended time under the deck. Such extended time allows the grass clippings to be cut multiple times. U.S. Pat. No. 5,019,113 discloses a rotatable blade assembly which is suitable for use on a rotary power lawn mower. The blade assembly includes an elongated bar member which rotates in a horizontal plane within the housing of a rotary lawn mower. Cutting blade elements having cutting edges formed at oppositely facing edges are detachably secured at diametrically opposed ends of the bar. The cutting blade elements can be secured to the bar member without the need for special tools for removing the blade assembly from the shaft of the mower motor.

U.S. Pat. No. 5,259,176 discloses a lawn mower including a cutter device which includes lower and upper cutter blades coupled to a rotatable shaft drivable by an engine and substantially horizontally rotatable. The lower cutter blade has a distal end region including a cutting edge facing in the direction of rotation. The upper cutter blade extends substantially parallel to the lower cutter blade, and has a distal end region including a cutting edge facing in the direction of rotation and positioned forwardly of the cutting edge of the lower cutter blade. The width of the distal end region of the lower cutter blade is larger than the width of the distal end region of the upper cutter blade. The distal end regions of the lower and upper cutter blades extend substantially parallel to each other and are vertically spaced from each other, with an air passage defined there between. The lower cutter blade has a substantially upwardly raised portion disposed behind the cutting edge thereof in the direction of rotation for directing an air flow upwardly in the air passage.

U.S. Pat. No. 5,383,329 discloses a combination lawn mower blade with replaceable cutting edge pieces mounted on the forwardly rotating cutting surfaces of the blade. The elongated blade has top and bottom surfaces with tips in a centrally located hole for attachment to an engine shaft of a rotary lawn mower. The blade has a set of grooves and steps which are cut into the forward cutting surfaces. The cutting edge pieces have a sharp cutting surface which inclines upwardly on top to a flat top surface, and also have a flat bottom surface. A channel in the cutting edge pieces is cut between the top and bottom surfaces and contains a set of grooves and steps matching those on the blade so the cutting edge pieces slide onto the blade from the direction of the center of the blade. The set of grooves and steps on the blade is cut so that a space is left between the cut and the tip of the blade. This allows the cutting edge pieces to be blocked from flying off the blade due to centrifugal force during rotation. The blade may have upwardly curved portions on the rearward edges near the tips of the blade opposite the cutting edge pieces to help produce aerodynamic lifting of the grass for better cutting.

U.S. Pat. No. 5,515,670 discloses a rotary lawn mower blade which has a plurality of shredders with cutting edges affixed to the blade. The shredders provide additional cutting edges for fine shredding of vegetation. These shredders may be bolted, welded or cut out of the blade. A ridge is provided for aiding the grass clippings to drop to the ground.

U.S. Pat. No. 6,052,979 discloses a blade for a rotary mower with a cup-like downward open cover for the seating of the blade. The blade has two sails that are provided on their front longitudinal edges in the direction of rotation with cutting edges. The cutting edges of the blade sails of the blade constitute several cutting planes, whereby the outer cutting edge section within the region of the sail extremities is located below the plane of the blade's hub portion. To this outer cutting edge section is attached a central cutting edge section that curves above the plane of the hub portion and changes over to an inner cutting edge section that drops off toward the hub portion. The sail extremities, of which the front longitudinal edges are positioned in the direction of rotation below the plane of the hub portion, are designed as guide surfaces at a slant with respect to the blade's plane of rotation. The guide surfaces curve upwards from the front longitudinal edges of the blade's sail in the direction of rotation toward the rear longitudinal edges. The rear longitudinal edges in the direction of rotation of the blade's sails extend within or above the plane of the hub portion. The guide surfaces cause the material cut by the outer cutting edge section to be lifted, thus repeatedly reaching the sphere of action of the central and the inner cutting edge sections. This action results in the cut material being repeatedly reduced in size until it is pulverized.

U.S. Pat. No. 6,487,840 discloses a rotary lawn mower blade with improved combined mulching and shredding capability which includes an outboard section having a leading cutting edge and a trailing edge. The trailing edge of the outboard section includes a plurality of teeth. The blade also includes a transition section having a leading cutting edge that is at least partially offset relative to the leading cutting edge of the outboard section. The transition section further includes a trailing edge having a partial tooth. The plurality of teeth on the outboard section is twisted in either an inboard or an outboard direction. Additionally, the partial tooth can be twisted in an inboard direction. The blade also preferably includes a central mounting portion and an inboard section between the central mounting portion and the transition section. The inboard section also includes a leading cutting edge and a trailing edge.

U.S. Pat. No. 7,299,612 discloses a rotary motor blade that has a rotational mounting structure in its body member to mount the blade to a power driven motor and thereby rotate the blade. The body member includes at least one free end extending outwardly of the mounting structure with the free end having a front leading edge and a rear trailing edge interconnected by a tip. At least a portion of the front leading edge is tapered to comprise a cutting edge. At least one, and preferably a plurality of air flow deforming elements such as indentations are formed in the front leading edge and extend inwardly from the exposed outer surface of the front leading edge to disturb air flow along the rotating blade and enhance the creation of vortices which allow the flow to go from the front leading edge to the rear trailing edge.

U.S. Pat. No. 7,392,643 discloses a lawn mower having upper and lower cutter blades positioned in cutter housing. The blades are disposed with a phase difference such that upper blade edge parts of the upper cutter blade are advanced forward with respect to the lower blade edges of the lower cutter blade in the rotation direction, whereby interference of the upper cutter blade with the air-lifting parts of the lower cutter blade is avoided, and the noise produced by the rotation of the upper and lower cutter blades is reduced.

U.S. Pat. No. 7,617,665 discloses a lawn mower which includes a mower deck that opens downward. The lawn mower further contains a plurality of vertical shafts rotatably supported by the mower deck and a plurality of cutting blades driven by the vertical shafts inside the mower deck. A cutting chamber is formed inside the mower deck and provides for each cutting blade. The lawn mower contains an opening which is formed between the cutting chambers for adjacent cutting blades. The cutting blades are arranged generally in a lateral direction with an adjacent pair of cutting blades being rotatably driven in opposite directions from each other. The opening allows for flow passage of cut grass at least from one of the cutting chambers to the other cutting chamber.

### SUMMARY OF THE INVENTION

The present invention is directed towards a rotary lawn mower blade constructed and arranged to disperse grass clippings out from the mowing device at a greater distance than typically seen using standard mowing blades. The rotary lawn mower blade includes a main body which has two opposing ends and an aperture which is used to attach to an engine, thereby allowing for rotation. The first end comprises a first leading cutting edge arranged opposite a first trailing edge. The first trailing edge has an upturned portion having sufficient height, length and configuration to redirect air flow generated when the main body is rotating to create pressurized air, thereby creating an increased force to disperse grass to the external environment. The second end comprises a second leading cutting edge arranged opposite a second trailing edge. The second trailing edge has an upturned portion having sufficient height, length and configuration to redirect air flow generated when the main body is rotating to create pressurized air, thereby creating an increased force to disperse grass to the external environment.

The rotary blade in accordance with the present invention has been found to have an effect on the air flow through the lawn mower deck and provides air circulation in which grass clippings dispensed from the discharge opening are expelled to the external environment at greater distances than mowing devices which use standard blades. It is believed that the configuration of the upturned portions redirects the air flow. As the blade is rotating, it imparts energy to the air causing the air, and grass clippings, to exit at a greater velocity than when it started. In addition to providing a greater dispensing distance, the air circulation created by the present invention has been found to minimize accumulation of grass clippings within the deck, thereby reducing clogging of the discharge opening.

Accordingly, it is a primary objective of the instant invention to provide an improved rotary blade which is capable of ejecting cut grass at a greater distance than standard mowing blades.

It is a further objective of the instant invention to provide an improved rotary blade which is capable of preventing cut grass clippings from clogging the lawn mower blade.

It is yet another objective of the instant invention to provide an improved rotary blade which contains a main body having multiple cutting surfaces and multiple upturned surfaces.

It is a further objective of the instant invention to provide a rotary blade which redirects air flow, resulting in grass clippings being dispersed to the external environment at a greater distance.

It is yet another objective of the instant invention to provide an improved rotary blade which contains upturned portions which redirect the air flow in such a manner that, as the blade is rotating it imparts energy to the air causing the air, and grass clippings, to exit at a greater velocity than when it started.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of a typical walking style lawn mower;

FIG. 2 is a perspective view of the bottom side of a walking style lawn mower, illustrating the connection of a rotary blade, such as described herein, to the lawn mower;

FIG. 3 is a schematic plan view of a particular embodiment of the present invention;

FIG. 4 is a top perspective view of the particular embodiment of the present invention illustrated in FIG. 3;

FIG. 5 is a partial perspective view of the present invention, illustrating the front side of the upturned portion;

FIG. 6 is a partial perspective view of the present invention, illustrating the back side of the upturned portion;

FIG. 7 is a front perspective view of the present invention;

FIG. 8 is a front elevational view of the rotary blade shown in FIGS. 3-7;

FIG. 9 is a perspective view of an alternative embodiment of the rotary blade illustrated in FIG. 4 without the notched areas;

FIG. 10 is a top view of an alternative embodiment of the instant invention;

FIG. 11 is a front elevational view of the rotary blade shown in FIG. 10.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

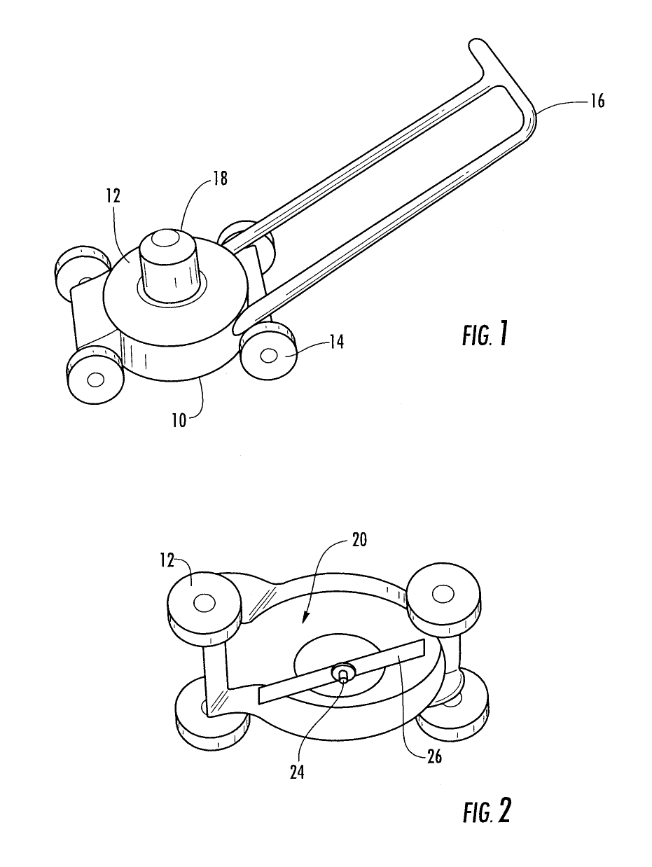

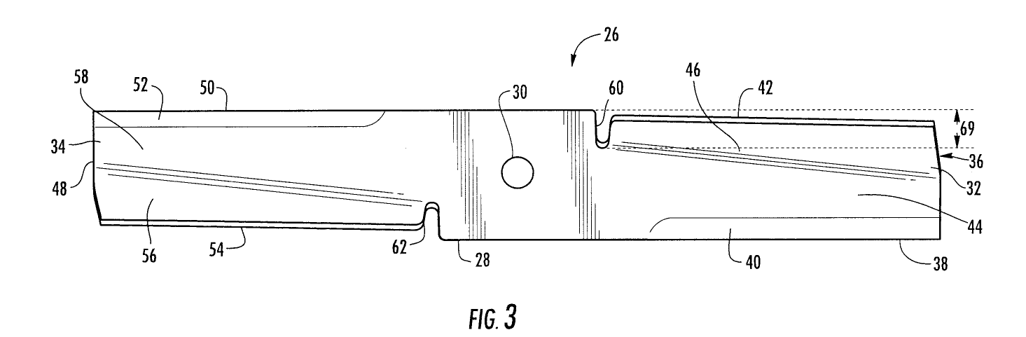

The instant invention may be adapted to fit any of the numerous types of cutting devices commercially available, including electric push mowers, gas powered (both push and self-propelled), lawn tractors, and large scale commercial mowers. FIG. 1 illustrates a standard push-type lawn mower typically used for residential purposes. The lawn mower 10 includes a main body portion, or deck, 12 to which is secured a cutting element, a plurality of wheels 14, a handle 16, and an engine 18. FIG. 2 illustrates the bottom of the lawn mower 10. Attached to the underside of the main body 20 is a rotary cutting element or blade 26, such as the cutting blade of the instant invention described herein. The cutting blade 26 is secured to the engine 18 through shaft 24 and fastening elements (not shown).

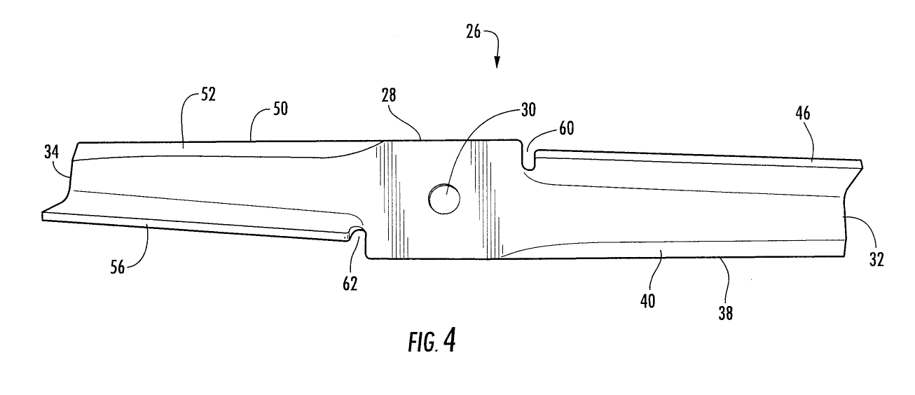

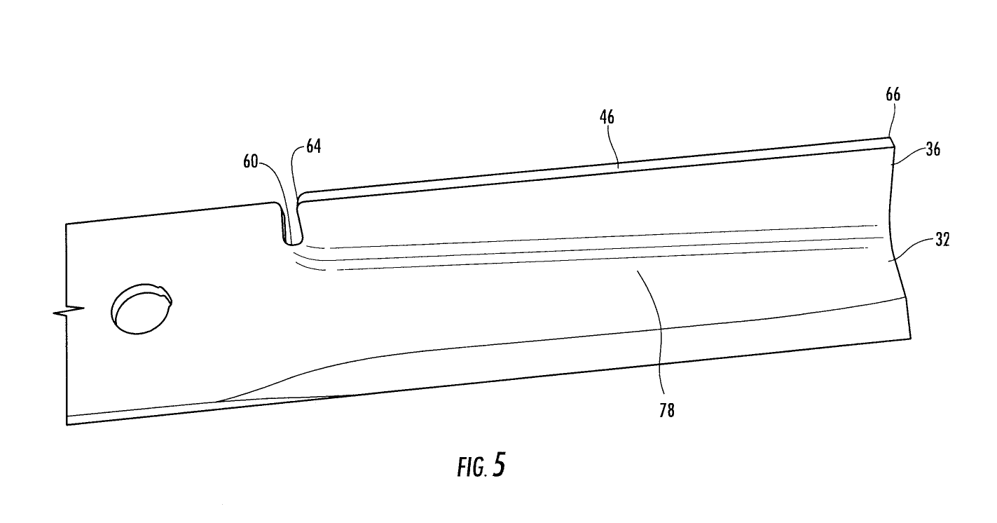

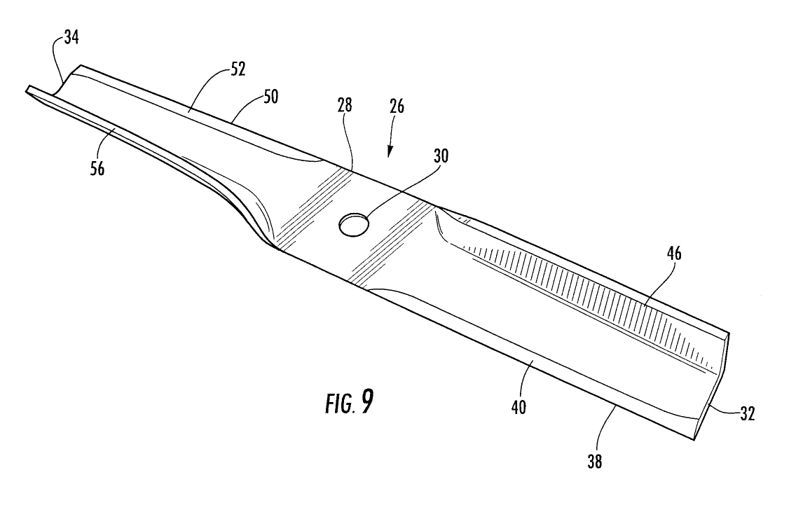

With reference to FIGS. 3-9, the rotary lawn mower blade of the present invention is shown and indicated by the number 26. Referring specifically to FIGS. 3 and 4, the rotary lawn mower blade 26 comprises a main body 28 illustrated as a mostly rectangular, elongated shape. The main body 28 contains an aperture 30, preferably positioned in the center, which is sized and shaped for attachment or coupling to a drive shaft of a lawn mower to provide the main body 28 rotary movement. The aperture 30 divides the main body 28 into a first end 32 and a second end 34. The first end 32 has a length defined by the distance measured from the center aperture to the distal end 36, i.e. the farthest distance from the aperture. The first end 32 is preferably constructed to have a first leading cutting edge 38, having a cutting surface 40, arranged opposite a first trailing edge 42. In between the first leading cutting edge 38 and the first trailing edge 42 is a generally planar surface 44. The first trailing edge 42 contains an upturned portion 46. The second end 34 has a length defined by the distance measured from the center aperture to the distal end 48, i.e. the end farthest from the aperture. The second end 34 is preferably constructed to have a second leading cutting edge 50, having a cutting surface 52, arranged opposite a second trailing edge 54. The second trailing edge 54 contains an upturned portion 56. In between the second leading cutting edge 50 and the second trailing edge 54 is a generally planar surface 58. Each of the ends 32 and 34 contain a notched portion 60 and 62. While the notched portions prevent distortion of the upturned portions, the rotary blade 26 may be constructed without such notches, see FIG. 9.

The upturned portions 46 and 56 are preferably constructed and arranged to have sufficient height, length, and/or configuration to redirect air flow generated when the body is rotating to increase the pressure and flow of the air as it rotates within the deck of the lawn mowing device. The upturned portions 46 and 56 are constructed in identical configuration. Accordingly, the upturned portion 46 will be described, it being understood that the same features are applicable to the upturned portion 56. As illustrated in FIG. 5, the upturned portion 46 contains a first end 64 beginning at, or near, the notched portion 60, and a second end 66 which terminates at the distal end 36 of the first end 32. The distance between the first end 64 and the second end 66 is defined as the length of the upturned portion 46. While the length of the upturned portion 46 can vary, in a preferred embodiment the length is equal to or greater than half the length of the first end, defined by the distance from the distal end 36 to the center of the aperture 30. In a more preferred embodiment, the length of the upturned portion 46 is at least equal to, or greater than three-quarters of the length defined by the distance from the distal end 36 to the center of the aperture 30. In an illustrative example for the blade 26 typically designed for a 50 inch Dixie Chopper, the length of the upturned portion 46 is 6.5 inches and the length of the first end 32 is 8.40 inches. Additionally, the length of the upturned portion 46 is preferably proportional to the length of the first leading cutting edge 38, and/or the cutting surface 40. However, this need not be the case as the first leading cutting edge 38, and/or the cutting surface 40 and the upturned portion 46 may be designed to have varying lengths relative to each other. The upturned portion 46 is preferably constructed with a slight forward pitch, 69, preferably at approximately 5 degrees.

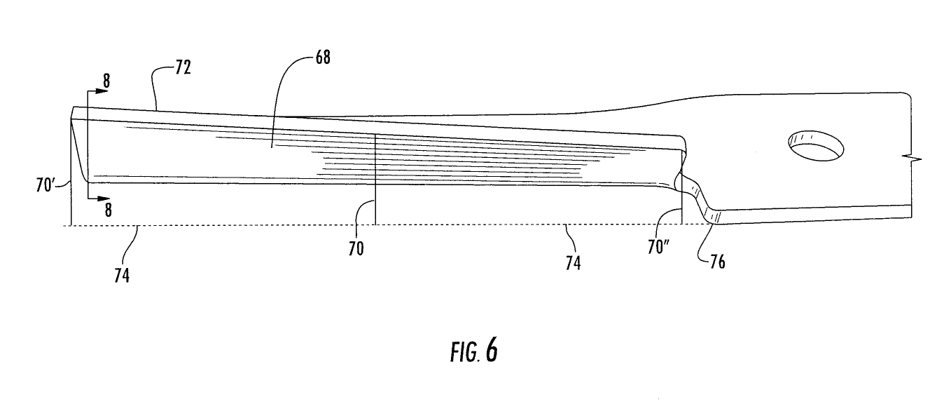

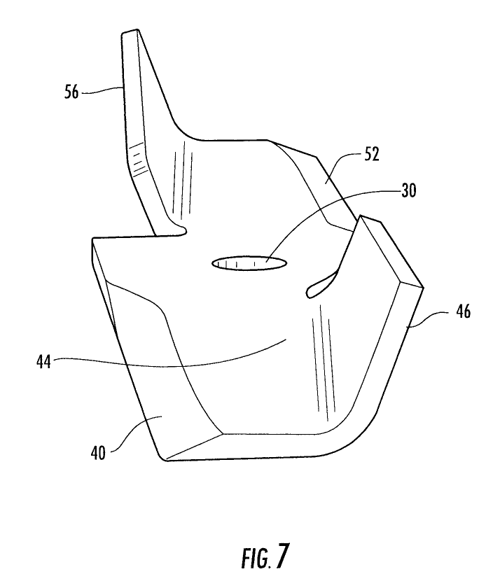

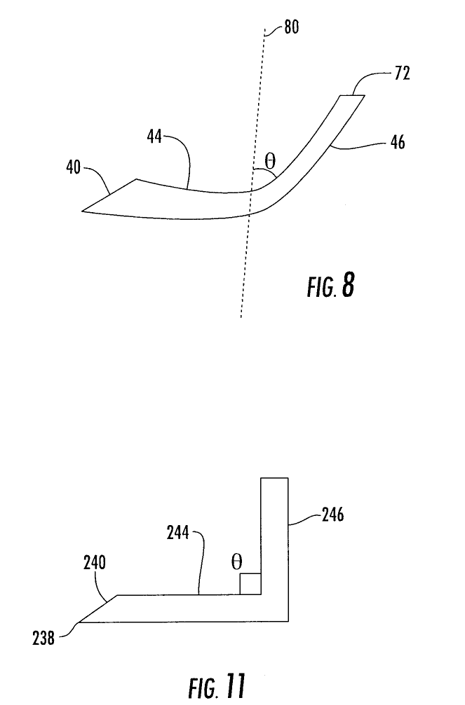

Referring to FIG. 6, the back surface 68 of the upturned portion 46 is illustrated. The height 70 of the upturned portion 46, which is defined as the distance between the top surface edge 72 and the plane illustrated by broken line 74, which extends from the bottom surface edge 76 of the blade 26, can vary. In a preferred embodiment, the height 70 is varied along the length of the upturned portion 46 so that the height 70′ near, or at the distal end 36 is greater than the height 70″ near the notched portion 60, with heights in between the distal end 36 and first end 34 gradually decreasing. The variable length construction allows the upturned portions to contain a twisted, inward configuration such that the point where the generally planar surface becomes the upturned portion moves inwardly toward the center of the blade 26 as the point nears the distal end 36. Alternatively, the height can be the same at each end and uniform there between. In addition to a length and height, the upturned portion can be defined by an angle θ which depending on the angle, provides the blade 26 with a convex portion on the front surface 78 (see FIG. 5) and a concave portion on the back surface 68. FIG. 7 is a front perspective view of the rotary blade 26, illustrating the angled aspect of the upturned portion 46 and the upturned portion 56. As illustrated in FIG. 8, the angle θ is preferably an angle that is less than or equal to 45 degrees with reference to the vertical axis 80 formed at the point where the generally planer surface ends and the upturned portion 46 begins. In a more preferred embodiment, the angle θ is approximately 20 degrees. In an alternative embodiment, angle θ can be varied along the length of the upturned portions. Angle θ may also be defined by the angle formed between the upturned portion and the generally planar surface.

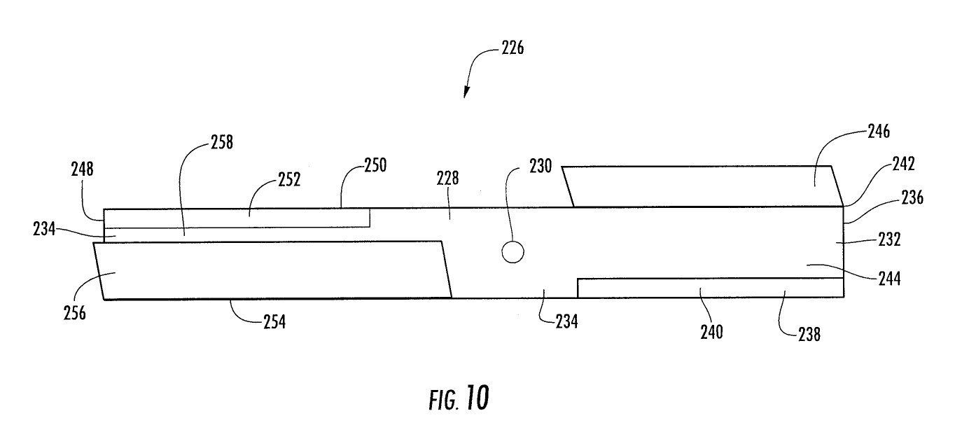

FIGS. 10 and 11 illustrate an alternative embodiment of the rotary lawn blade. Similar to rotary lawn mower blade 26 illustrated in FIGS. 3 and 4, the rotary blade 226 includes a main body 228, illustrated as a mostly rectangular, elongated shape. The main body 228 contains an aperture 230, preferably positioned in the center, which is sized and shaped for attachment or coupling to a drive shaft of a lawn mower to provide the main body 228 rotary movement. The aperture 230 divides the main body 228 into a first end 232 and a second end 234. The first end 232 contains a distal end, i.e. the farthest distance from the aperture, 236. The first end 232 is preferably constructed to have a first leading cutting edge 238, having a cutting surface 240, arranged opposite a first trailing edge 242. In between the first leading cutting edge 238 and the first trailing edge 242 is a generally planar surface 244. The first trailing edge 242 contains an upturned portion 246. The second end 234 contains a distal end, i.e. the end farthest from the aperture, 248. The second end 234 is preferably constructed to have a second leading cutting edge 250, having a cutting surface 252, arranged opposite a second trailing edge 254. The second trailing edge 254 contains an upturned portion 256. In between the second leading cutting edge 250 and the second trailing edge 254 is a generally planar surface 258. Each of the ends 232 and 234 may contain notched portions, not illustrated. Similar to the rotary blade 26 described previously, the rotary blade 226, the upturned portions 246 and 256 are preferably constructed and arranged to have sufficient height and length to redirect air flow generated when the body is rotating to increase the pressure and flow of the air as it rotates within the deck of the lawn mowing device. As the air flow is redirected, the cut grass clippings, as well as the air, are accelerated as both are directed outward from the center of rotation. Unlike the upturned portions 46 and 56 illustrated in FIGS. 3 and 4, upturned portions 246 and 256 are generally linear, thus forming right angles with the generally planer surfaces 244 and 258. In this manner, the angle θ is zero or close to zero degrees.

In use, the rotary lawn mower blade 26 (or 226) can be secured to any electric motor or gasoline powered engine. Both of these sources of power are commonly used on lawn mowers. Once secured in place by any manner known to one of skill in the art, the engine or motor generates a rotational force which results in rotation of the blade 26. As the blade spins, it creates a cutting force wherein cutting edges can cut multiple grass blades. While lifting blades are used to create a draft which pulls the grass blades up, and mulching blades utilize notched or raked-teeth-like edges to allow the clipped grass to revolve around the deck a longer time, the blade of the present invention improves upon existing blades by providing a blade that is designed to redirect air flow in order to increase the pressure and flow of the air as it rotates within the deck of the lawn mowing device. As a result of the length, height, and/or the configuration of the upturned portions, the air generated by the rotation becomes pressurized. Air drawn into the deck of the mowing machine is redirected so that the air flow is accelerated radially outward toward the periphery of the blade and/or the deck and discharged at a high pressure. In addition to creating an outward force upon the air, some energy pushes the air into a circular motion which has the added effect of increasing pressure at the outlet point, i.e. place where the grass is expelled to the external environment. The deck of the cutting device also helps to maintain the pressure by preventing air, and the grass clippings, from being flung in multiple directions.

It is believed that the mechanical energy, therefore, is converted to pressure energy by means of centrifugal forces acting on the air and/or the cut grass. As the blade rotates, it imparts energy to the circulating air causing the air to exit out the mowing device at a greater velocity than when it started. While other mower blades are capable of dispersing cut grass away from the mower, the blade of the present invention distributes the cut grass to the external environment at unexpectedly greater distances than other known blades. Under experimental testing conditions, i.e. same time and under same conditions, the distance for which cut grass was dispersed relative to the mower was compared in a mower using the blade of the present invention and using a standard blade. Under these conditions, the mowing devices using standard blades dispersed grass cuttings no more than 3 feet. Mowing devices using the blade in accordance with the present invention dispersed grass at a distance at least two times that of a standard blade, to a distance of at least 6 feet. Moreover, the lawn mowing devices using these blades were not subject to becoming clogged by the cut grass as much as when using a standard blade.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A rotary lawn mower blade for cutting grass comprising:
a generally elongated rectangular body having an aperture for attachment to a drive shaft of a lawn mower to provide said body rotary movement, said aperture dividing said body into a first end and a second end;
said first end having a first leading cutting edge arranged opposite a first trailing edge, said first trailing edge having an upturned portion having sufficient height, length and configuration to impart energy to the circulating air causing the air to exit out the lawn mower at a greater velocity than when it started;
said second end having a second leading cutting edge arranged opposite a second trailing edge, said second trailing edge having an upturned portion having sufficient height, length and configuration to impart energy to the circulating air causing the air to exit out the lawn mower at a greater velocity than when it started;

2. The rotary lawn mower blade for cutting grass according to claim 1 wherein said body includes at least one notched section adjacent said upturned portion.

3. The rotary lawn mower blade for cutting grass according to claim 2 wherein the length of said first upturned portion and the length of said second upturned portion extend from said notched portions to said distal ends.

4. The rotary lawn mower blade for cutting grass according to claim 3 wherein the length of said first leading cutting edge and the length of said second leading cutting edge extend from said notched portion to said distal ends.

5. The rotary lawn mower blade for cutting grass according to claim 4 wherein the height of said upturned portions closest to said aperture is smaller than the height of said upturned portion furthest from said center aperture.

6. The rotary lawn mower blade for cutting grass according to claim 5 wherein the height of said upturned portions between the portions closest to said aperture and said upturned portion furthest from said aperture is varied.

7. The rotary lawn mower blade for cutting grass according to claim 5 wherein said length of said cutting edge and the length of said upturned portions are substantially similar.

8. The rotary lawn mower blade for cutting grass according to claim 7 wherein the length of each said upturned portion is at least half the length of each end.

9. The rotary lawn mower blade for cutting grass according to claim 7 wherein the length of each said upturned portion is at least three quarters of the length of each end.

10. The rotary lawn mower blade for cutting grass according to claim 7 wherein said upturned portions have an angle which is less than 45 degrees from the vertical axis.

11. The rotary lawn mower blade for cutting grass according to claim 7 wherein said angle is approximately 20 degrees.

12. The rotary lawn mower blade for cutting grass according to claim 11 wherein said upturned portion further includes an inwardly twist toward the center of said blade.

13. The rotary lawn mower blade for cutting grass according to claim 2 wherein said upturned portion forms a 90 degree angle from the longitudinal axis.
